(19) United States
(12) Patent Application Publication
(10) Pub. No.: US 2007/0146936 A1
(43) Pub. Date: Jun. 28, 2007

(54) Recording medium drive including latch member for head actuator member

(75) Inventors: Kazunori Akama, Kawasaki (JP); Yasuhiko Kato, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/373,574

(22) Filed: Mar. 10, 2006

(30) Foreign Application Priority Data
Dec. 26, 2005 (JP) 2005-373111

(51) Int. Cl. G11B 5/54

(52) U.S. Cl. 360/256.2

(57) ABSTRACT

A head actuator member is supported on a support shaft for swinging movement. A voice coil motor is connected to the head actuator member. A protuberance is formed on the head actuator member. The protuberance moves along a predetermined movement path around the support shaft. A latch member is supported on a rotation shaft for swinging movement to reach an operative position established on the movement path of the protuberance. The latch member engages with the protuberance at the operative position. A magnetic body on the latch member receives a magnetic attraction of the voice coil motor when the latch member is located at the operative position. The latch member is forced to stay at the operative position. Even if the head actuator member starts swinging later than the swinging movement of the latch member, the latch member reliably engages with the protuberance on the head actuator member.

### BACKGROUND OF THE INVENTION

1. Field of the Invention

The present invention relates to a recoding medium drive such as a hard disk drive, HDD, for example. In particular, the invention relates to a recording medium drive including a recording medium and a ramp member located outside the recording medium.

2. Description of the Prior Art

A head actuator member or carriage is incorporated in a hard disk drive. The carriage is designed to swing around a support shaft along a predetermined movement path. When the carriage swings farthest in a normal direction outward from a magnetic recording disk, the carriage is located at a standby position. The tip end of the carriage is received on a ramp member. On the other hand, when the carriage swings in a reverse direction opposite to the normal direction, the tip end of the carriage gets away from the ramp member.

A latch member is incorporated in the hard disk drive. The latch member is designed to swing around a predetermined rotation shaft from an inoperative position. When the latch member swings by the maximum rotation angle, the latch member is allowed to get into the movement path of the carriage. On the other hand, when the latch member is located at the inoperative position, the latch member is out of the movement path of the carriage. The carriage is thus allowed to pass by the latch member, so that the carriage swings in the reverse direction so as to get distanced from the ramp member.

Assume that the hard disk drive falls on the floor when the magnetic recording disk stands still. An impact serves to drive the carriage in the normal direction from the standby position, for example. The impact also serves to drive the latch member for swinging movement from the inoperative position, so that the latch member gets into the movement path of the carriage. The latch member thus engages with the carriage. The carriage is restrained from the swinging movement. The carriage is thus held on the ramp member.

However, if the carriage starts swinging late, the swinging movement of the carriage cannot synchronize with the swinging movement of the latch member. The latch member rebounds back to the inoperative position, for example. The latch member thus fails to engage with the carriage. The carriage is allowed to get away from the ramp member. A flying head slider contacts with the surface of the magnetic recording disk. This results in attachment of the flying head slider to a lubricant agent covering over the surface of the magnetic recording disk. The magnetic recording disk thus cannot start rotating.

### SUMMARY OF THE INVENTION

It is accordingly an object of the present invention to provide a recording medium drive capable of reliably holding a head actuator member on a ramp member.

According to the present invention, there is provided a recording medium drive comprising: a head actuator member supported on a support shaft for swinging movement around the support shaft; a voice coil motor connected to the head actuator member for driving the head actuator member; a protuberance formed on the head actuator member, the protuberance moving along a predetermined movement path around the support shaft; a latch member supported on a rotation shaft for swinging movement to reach an operative position established on the movement path of the protuberance, the latch member engaging with the protuberance at the operative position; and a magnetic body located on the latch member, the magnetic body receiving a magnetic attraction of the voice coil motor when the latch member is located at the operative position.

The recording medium drive allows the magnetic body on the latch member at the operative position to receive the magnetic attraction of the voice coil motor. The latch member is thus forced to stay at the operative position. Accordingly, even if the head actuator member starts swinging later than the swinging movement of the latch member, the latch member is allowed to reliably engage with the protuberance on the head actuator member. The head actuator member is thus reliably restrained from the swinging movement.

The recording medium drive may further include a further magnetic body located on the latch member. The further magnetic body is designed to receive the magnetic attraction of the voice coil motor when the latch member is located at an inoperative position established outside the movement path of the protuberance. The further magnetic body serves to drive the latch member from the operative position to the inoperative position. The magnetic member can in this manner be released from the magnetic attraction of the voice coil motor. The latch member is allowed to return to the inoperative position. The protuberance is thus allowed to pass by the latch member along the movement path.

The interval between the rotation shaft and the magnetic body may be set larger than the interval between the rotation shaft and the further magnetic body in the magnetic medium drive. This structure enables the magnetic body to have a larger amount of the movement as compared with the further magnetic body for a unit rotation angle. In this case, when the rotation angle increases, the further magnetic body is gradually released from the magnetic attraction of the voice coil motor while the magnetic body is allowed to receive a rapidly increasing magnetic attraction. The magnetic attraction established for the magnetic body on the latch member at the operative position is set larger than the magnetic attraction established for the further magnetic body on the latch member at the inoperative position.

The latch member may include a flat surface designed to contact with the protuberance of the head actuator member. The head actuator member swings around the support shaft. The protuberance contacts with the latch member located at the operative position. The head actuator member is first received on the latch member at an edge of the flat surface. In this case, the flat surface allows a further swinging movement of the head actuator member. This movement serves to push back the edge of the flat surface around the rotation shaft. The latch member is in this manner forced to swing back toward the inoperative position from the operative position. This swinging movement of the latch member serves to reduce space between the flat surface and the protuberance. When the entire flat surface is brought in contact with the head actuator member, the latch member is restrained from a further swinging movement. The latch member keeps engagement with the head actuator member.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a plan view schematically illustrating the inner structure of a hard disk drive, HDD, as a specific example of a recording medium drive according to an embodiment of the present invention;

FIG. 2 is an enlarged partial plan view schematically illustrating the inner structure of the hard disk drive;

FIG. 3 is an enlarged partial plan view schematically illustrating the inner structure of the hard disk drive;

FIG. 4 is a graph showing the relationship between the rotation angle of a latch member and the amount of torque;

FIG. 5 is an enlarged partial plan view schematically illustrating the latch member swinging from an inoperative position to an operative position;

FIG. 6 is an enlarged partial plan view schematically illustrating the latch member receiving a head actuator member at the operative position; and

FIG. 7 is an enlarged partial plan view schematically illustrating the latch member engaging with the head actuator member at a restraint position.

### DESCRIPTION OF THE PREFERRED EMBODIMENT

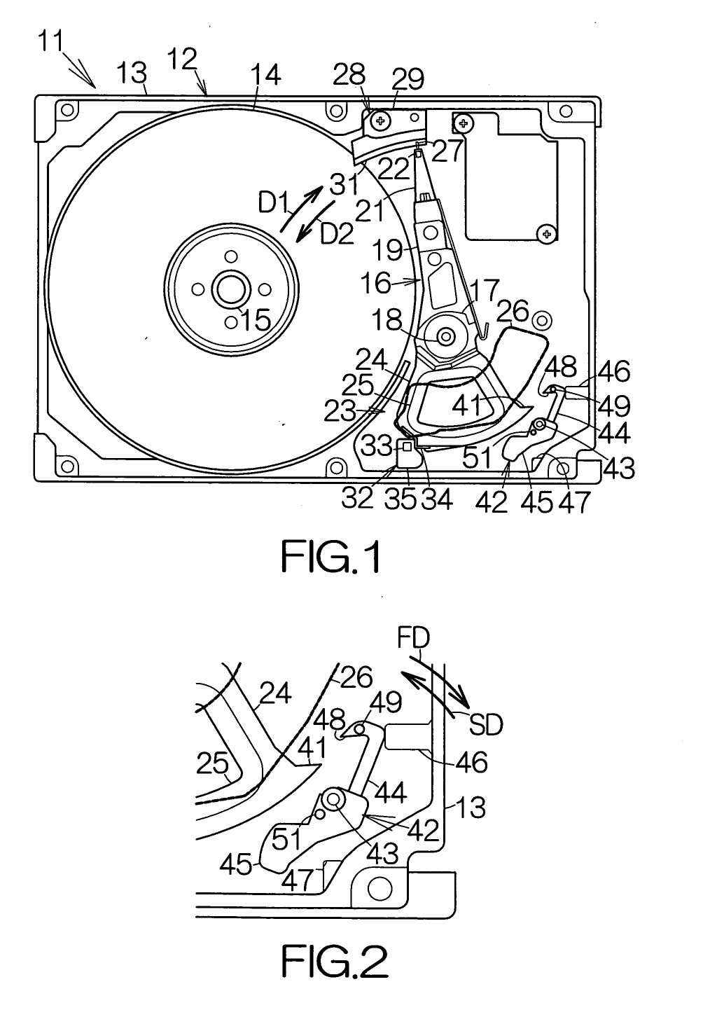

FIG. 1 schematically illustrates the inner structure of a hard disk drive, HDD, 11 as a specific example of a recoding medium drive according to an embodiment of the present invention. The hard disk drive 11 includes a box-shaped enclosure 12. The enclosure 12 includes a box-shaped base 13 defining an inner space of a flat parallelepiped opened upward, for example. The base 13 may be made of a metallic material such as aluminum, for example. Molding process may be employed to form the base 13.

A cover, not shown, is coupled to the base 13. The cover serves to close the opening of the base 13. Pressing process may be employed to form the cover out of a plate, for example. An aluminum plate may be employed as the plate, for example. The plate may alternatively be a layered material, for example.

At least one magnetic recording disk 14 as a recording medium is incorporated within the inner space of the base 13. The magnetic recording disk or disks 14 is mounted on the driving shaft of a spindle motor 15. The spindle motor 15 drives the magnetic recording disk or disks 14 at a higher revolution speed such as 5,400 rpm, 7,200 rpm, 10,000 rpm, 15,000 rpm, or the like.

A head actuator member, namely a carriage 16 is also incorporated within the inner space of the base 13. The carriage 16 includes a carriage block 17. The carriage block 17 is supported on a vertical support shaft 18 for relative rotation. Carriage arms 19 are defined in the carriage block 17. The carriage arms 19 are designed to extend in the horizontal direction from the support shaft 18. The carriage block 17 may be made of aluminum, for example. Extrusion molding process may be employed to form the carriage block 17.

An elastic head suspension 21 is fixed to the tip end of the individual carriage arm 19. The head suspension 21 is designed to extend forward from the tip end of the carriage arm 19. A gimbal spring, not shown, is connected to the tip end of the individual head suspension 21. A flying head slider 22 is fixed to the surface of the gimbal spring. The gimbal spring allows the flying head slider 22 to change its attitude relative to the head suspension 21.

An electromagnetic transducer, not shown, is mounted on the flying head slider 22. The electromagnetic transducer may include a write element and a read element. The write element may include a thin film magnetic head designed to write magnetic information data into the magnetic recording disk 14 by utilizing a magnetic field induced at a thin film coil pattern. The read element may include a giant magnetoresistive (GMR) element or a tunnel-junction magnetoresistive (TMR) element designed to discriminate magnetic information data on the magnetic recording disk 14 by utilizing variation in the electric resistance of a spin valve film or a tunnel-junction film, for example.

When the magnetic recording disk 14 rotates, the flying head slider 22 is allowed to receive an airflow generated along the rotating magnetic recording disk 14. The airflow serves to generate a positive pressure or a lift as well as a negative pressure on the flying head slider 22. The flying head slider 22 is thus allowed to keep flying above the surface of the magnetic recording disk 14 during the rotation of the magnetic recording disk 14 at a higher stability established by the balance between the urging force of the head suspension 21 and the combination of the lift and the negative pressure.

When the carriage 16 is driven to swing around the support shaft 18 during the flight of the flying head slider 22, the flying head slider 22 is allowed to move in the radial direction of the magnetic recording disk 14. The electromagnetic transducer on the flying head slider 22 is thus allowed to cross the data zone defined between innermost and outermost recording tracks. The electromagnetic transducer can thus be positioned right above a target recording track on the magnetic recording disk 14.

A voice coil motor, VCM, 23 is connected to the carriage block 17. A support body 24 is formed integral with the carriage block 17. The support body 24 is designed to extend in the horizontal direction from the support shaft 18. A coil 25 of the voice coil motor 23 is wound around the support body 24. The support body 24 is opposed to a permanent magnet 26 fixed to the base 13. When a magnetic field is induced in the coil 25 in response to the supply of electric current, the carriage 16 is driven to swing.

A load member, namely a load tab 27, is attached to the front or tip end of the head suspension 21. The load tab 27 is designed to extend forward from the head suspension 21. The load tab 27 is allowed to move in the radial direction of the magnetic recording disk 14 based on the swinging movement of the carriage 16. A ramp member 28 is located outside the magnetic recording disk 14 on the movement path of the load tab 27. The load tab 27 is received on the surface of the ramp member 28.

The ramp member 28 includes an attachment base 29 fixed to the base 13 outside the magnetic recording disk 14. The attachment base 29 may be screwed in the bottom plate of the base 13. The ramp member 28 also includes ramps 31 extending from the attachment base 29 toward the vertical support shaft 18 of the carriage 16 in the horizontal direction. The ramps 31 are formed integral to the attachment base 29 based on molding process, for example. The tip end of the ramp 31 is opposed to a non-data zone outside the outermost recording track on the magnetic recording disk 14. The ramp member 28 and the load tabs 27 in combination establish a so-called load/unload mechanism. The ramp member 28 may be made of a hard plastic material, for example.

A retention mechanism 32 is related to the carriage 16. The retention mechanism 32 includes a permanent magnet 33 fixed to the base 13 and a magnetic piece or metallic piece 34 opposed to the permanent magnet 33. The permanent magnet 33 is embedded in a support member 35 fixed to the base 13. The support member 35 may be made of an elastic resin material such as rubber, for example. The metallic piece 34 is attached to an end of the support body 24. The metallic piece 34 is subjected to the magnetic attraction of the permanent magnet 33. The magnetic attraction of the permanent magnet 33 serves to keep the support body 24 of the carriage 16 in contact with the support member 35.

As is apparent from FIG. 1, when the carriage 16 swings farthest in a normal direction D1 outward the magnetic recording disk 14, the metallic piece 34 is received on the support member 35. The load tabs 27 are received on the ramp member 28. The carriage 16 in this manner reaches a standby position. On the other hand, when the carriage 16 swings from the standby position in the reverse direction D2 opposite to the normal direction D1, the load tabs 27 take off from the ramp member 28.

A protuberance 41 is formed in the support body 24 of the carriage 16. The protuberance 41 is designed to extend along an imaginary arc concentric to the longitudinal axis of the support shaft 18. The protuberance 41 may be formed integral with the support body 24. The protuberance 41 moves along a predetermined movement path on the imaginary arc during the swinging movement of the carriage 16.

A latch member 42 is related to the protuberance 41. The latch member 42 is supported on a rotation shaft 43 for relative rotation. The rotation shaft 43 is designed to stand upright from the base 13. The latch member 42 includes a first swinging piece 44 and a second swinging piece 45. The first and second swinging pieces 44, 45 are designed to extend in the opposite direction from the rotation shaft 43 in the horizontal direction. As shown in FIG. 2, when the latch member 42 is positioned at an inoperative position around the rotation shaft 43, the first swinging piece 44 gets out of the movement path of the protuberance 41. The first swinging piece 44 is received on a receiving member 46 integral to the base 13. The receiving member 46 serves to prevent a further swinging movement of the latch member 42 in a first direction FD.

The latch member 42 swings around the rotation shaft 43 from the inoperative position in a second direction SD opposite to the first direction FD. When the latch member 42 swings by the maximum rotation angle in the second direction SD, the latch member 42 reaches an operative position. As shown in FIG. 3, the first swinging piece 44 gets into the movement path of the protuberance 41. The second swinging piece 45 is received on a receiving member 47 integral to the base 13. The receiving member 47 serves to prevent a further swinging movement of the latch member 42 in the second direction SD. In this case, the maximum rotation angle is set at 15 degrees, for example. The latch member 42 may be made of a resin material such as polyacetal resin (POM), for example.

A flat surface 48 is defined on the first swinging piece 44 at a surface facing the rotation shaft 43. An edge of the flat surface 48 is designed to extend in parallel with the support shaft 18 and the rotation shaft 43. When the latch member 42 is positioned at the operative position, the inner edge of the flat surface 48 is prepared to contact with the protuberance 41. The inner edge of the flat surface 48 engages with the protuberance 41 swinging around the support shaft 18 in the reverse direction D2. Once the latch member 42 takes the operative position, the flat surface 48 is set to have a larger interval from the protuberance 41 at a position remoter from the support shaft 18.

A first magnetic piece 49 is located on the first swinging piece 44. When the latch member 42 swings around the rotation shaft 43 by the maximum rotation angle, the first magnetic piece 49 is subjected to the magnetic attraction from a yoke member, not shown, of the voice coil motor 23. The magnetic attraction serves to hold the latch member 42 at the operative position. An iron ball may be employed as the first magnetic piece 49, for example. The first magnetic piece 49 may be embedded in the first swinging piece 44.

A second magnetic piece 51 is located on the second swinging piece 45. When the latch member 42 is located at the inoperative position, the second magnetic piece 51 is subjected to the magnetic attraction from the yoke member of the voice coil motor 23. The magnetic attraction serves to hold the latch member 42 at the inoperative position. An iron ball may be employed as the second magnetic piece 51, for example. The second magnetic piece 51 may be embedded in the second swinging piece 45.

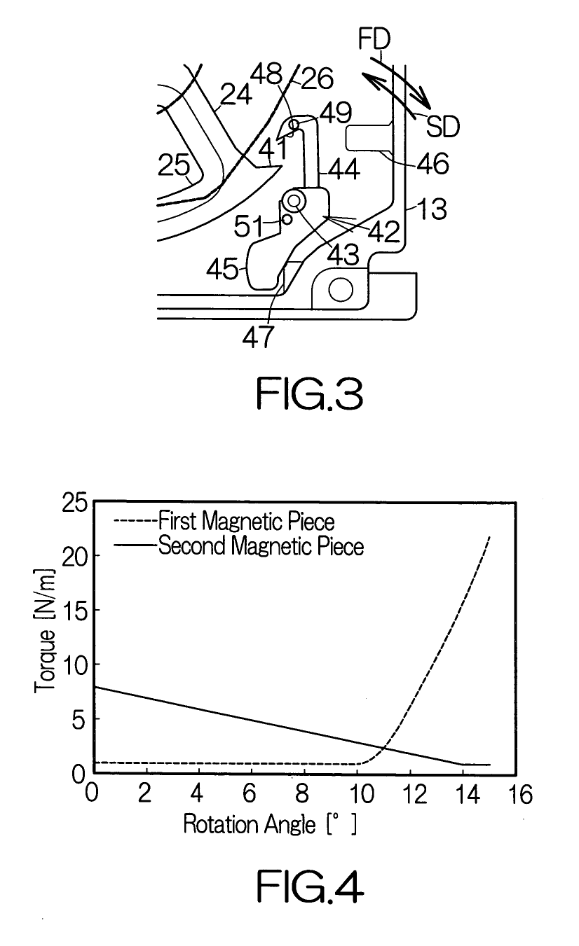

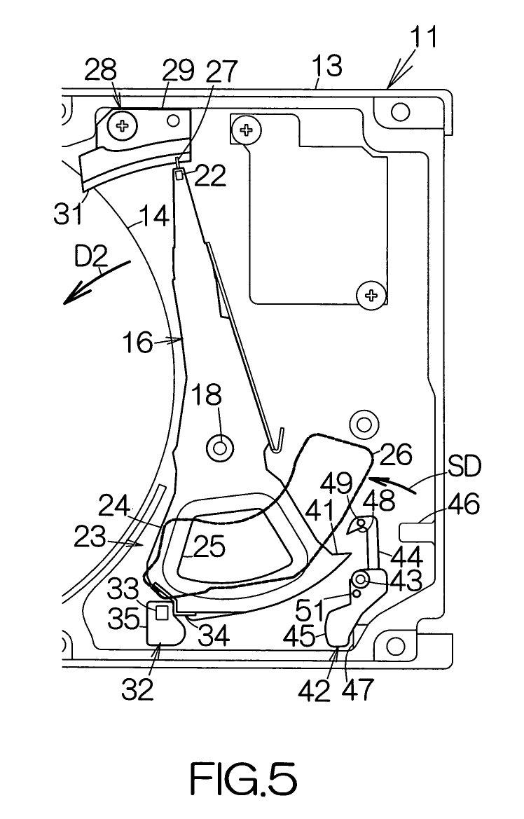

Here, the interval between the rotation shaft 43 and the first magnetic piece 49 is set significantly larger than the interval between the rotation shaft 43 and the second magnetic piece 51. This structure enables the first magnetic piece 49 to have a significantly larger amount of the movement as compared with the second magnetic piece 51 for a unit rotation angle. As is apparent from FIG. 4, the second magnetic piece 51 stays within the magnetic flux of the yoke member in a range from the rotation angle of zero degree to the rotation angle of 14 degrees. On the other hand, the first magnetic piece 49 stays within the magnetic flux of the yoke member in a range from the rotation angle of 10 degrees to the rotation angle of 15 degrees. When the rotation angle increases from zero degree, the second magnetic piece 51 is gradually released from the magnetic attraction of the yoke member while the first magnetic piece 49 is allowed to receive a rapidly increasing magnetic attraction. The magnetic attraction established for the first magnetic piece 49 on the latch member 42 at the operative position is set significantly larger than the magnetic attraction established for the second magnetic piece 51 on the latch member 42 at the inoperative position. When the rotation angle exceeds 11 degrees, the magnetic attraction for the first magnetic piece 49 exceeds the magnetic attraction for the second magnetic piece 51. The latch member 42 is allowed to enjoy a torque in the first direction FD unless the rotation angle exceeds 11 degrees. The latch member 42 is allowed to enjoy a torque in the second direction SD when the rotation angle exceeds 11 degrees.

Now, assume that the magnetic recording disk or disks 14 stop rotating. The latch member 42 is positioned at the inoperative position. When the read/write operation has been completed, the voice coil motor 23 drives the carriage 16 for swinging movement around the support shaft 18 in the normal direction D1. The carriage arms 19 and the head suspensions 21 are driven outward from the magnetic recording disk or disks 14. When the flying head sliders 22 get opposed to the landing zones or non-data zones outside the outermost recording tracks, the load tabs 27 contact with the ramps 31. A further swinging movement of the carriage arms 19 allows the load tabs 27 to climb up inclined surfaces defined on the ramps 31. The load tabs 27 get remoter from the corresponding surfaces of the magnetic recording disk or disks 14.

A further swinging movement of the carriage arms 19 in the normal direction D1 allows the load tabs 27 to slide on the ramps 31. When the load tabs 27 reach the farthest position from the magnetic recording disk or disks 14, the metallic piece 34 in the support body 24 is received on the support member 35. The load tabs 27 are received on the ramp member 28. The carriage 16 in this manner reaches the standby position. The magnetic recording disk or disks 14 then stop rotating. Since the load tabs 27 are reliably held on the ramp member 28, the flying head sliders 22 are prevented from contacting with the magnetic recording disk or disks 14 even without any airflow acting on the flying head sliders 22. The flying head sliders 22 are thus effectively prevented from any attachment to a lubricant agent covering over the surfaces of the magnetic recording disk or disks 14.

When the hard disk drive 11 receives instructions for the read/write operation, the magnetic recording disk or disks 14 first start rotating. The voice coil motor 23 drives the carriage 16 around the support shaft 18 in the reverse direction D2 after the rotation of the magnetic recording disk or disks 14 enter a steady condition. The carriage arms 19 and the head suspensions 21 are driven toward the rotation axis of the magnetic recording disk or disks 14. The load tabs 27 slide on the ramps 31. A further swinging movement of the carriage arms 19 allows the load tabs 27 to move down the inclined surfaces of the ramps 31.

The flying head sliders 22 get opposed to the corresponding surfaces of the magnetic recording disk or disks 14 during the downward movement of the load tabs 27. The flying head sliders 22 enjoy a lift based on an airflow generated along the corresponding surfaces of the rotating magnetic recording disk or disks 14. A further swinging movement of the carriage arms 19 in the reverse direction D2 then allows the load tabs 27 to get off from the ramp member 28. The steady rotation of the magnetic recording disk or disks 14 allows the flying head sliders 22 to keep flying above the corresponding surfaces of the rotating magnetic recording disk or disks 14 even without a support of the ramp member 28. The carriage 16 is in this manner allowed to swing along a predetermined movement path.

Now, assume that the hard disk drive 11 is switched off. As shown in FIG. 1, the magnetic attraction of the permanent magnet 33 keeps the metallic piece 34 in contact with the support member 35. The carriage 16 is held at the standby position. The latch member 42 is positioned at the inoperative position. Since the latch member 42 is subjected to the torque in the first direction FD, the latch member 42 is forced to stay at the inoperative position. If a driving force is induced in the reverse direction D2 based on an impact acting on the hard disk drive 11, for example, the carriage 16 swings around the support shaft 18 in the reverse direction D2 from the standby position against the magnetic attraction of the permanent magnet 33. The support body 24 swings around the support shaft 18. The load tabs 27 slide on the ramps 31 toward the corresponding surfaces of the magnetic recording disk or disks 14.

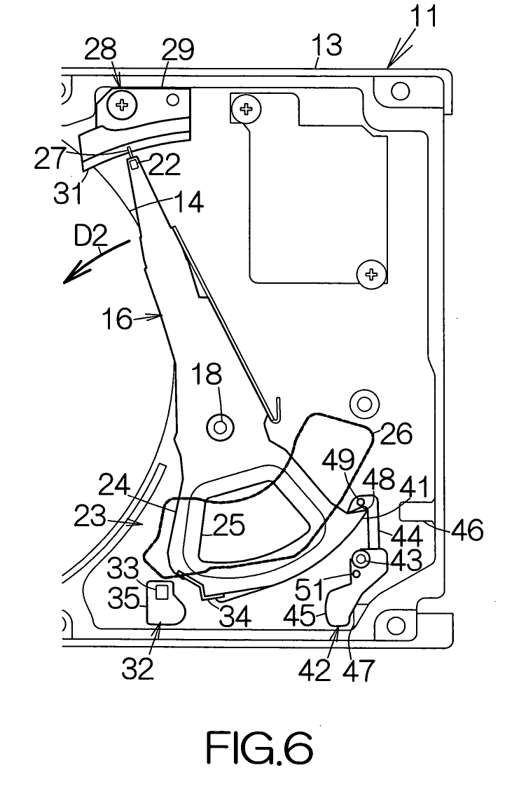

The latch member 42 simultaneously swings around the rotation shaft 43 in the second direction SD against the torque in the first direction FD. The latch member 42 swings by the maximum rotation angle of 15 degrees. The second swinging piece 45 is received on the receiving member 47. The first swinging piece 44 is allowed to get into the movement path of the protuberance 41, as shown in FIG. 5. The latch member 42 is in this manner positioned at the operative position. Since the latch member 42 is subjected to the torque in the second direction SD at the operative position, the latch member 42 is forced to stay at the operative position. The latch member 42 at the operative position is allowed to reliably engage with the protuberance 41, as shown in FIG. 6. The latch member 42 receives the protuberance 41 at the inner edge of the flat surface 48. The flat surface 48 keeps a larger space from the protuberance 41 at a position remoter from the support shaft 18.

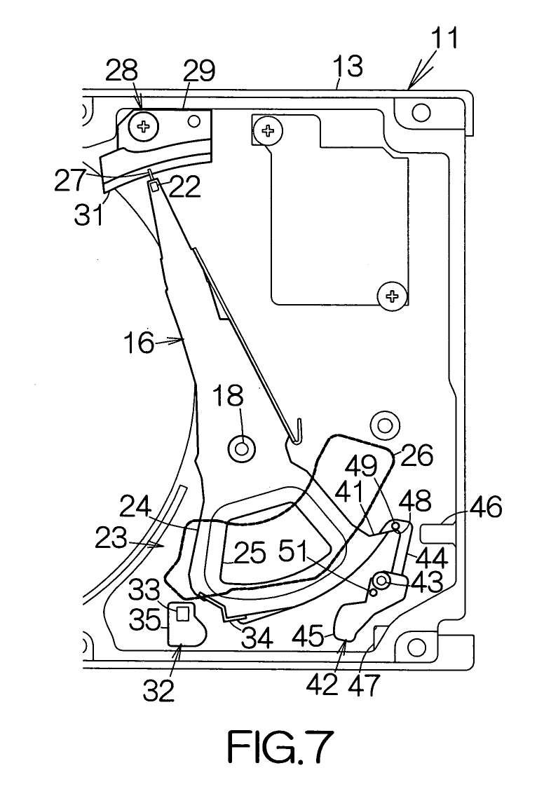

A further swinging movement of the carriage 16 serves to push back the inner edge of the flat surface 48 around the rotation shaft 43. The latch member 42 is in this manner forced to swing back around the rotation shaft 43 from the operative position toward the inoperative position against the torque in the second direction SD. This swinging movement of the latch member 42 serves to reduce the space between the flat surface 48 and the surface of the protuberance 41. When the latch member 42 swings back by a rotation angle beyond four degrees from the operative position, the entire flat surface 48 is brought in contact with the surface of the protuberance 41, as shown in FIG. 7. The latch member 42 in this manner reaches a restraint position. The latch member 42 is restrained from a further swinging movement. The latch member 42 also keeps engagement with the carriage 16. The carriage 16 is thus prevented from the swinging movement. The load tabs 27 are in this manner prevented from movement toward the magnetic recording disk or disks 14. The load tabs 27 are held on the ramp member 28. The flying head sliders 22 are thus prevented from contact with the magnetic recording disk or disks 14. The flying head sliders 22 are reliably prevented from any attachment to a lubricant agent covering over the surfaces of the magnetic recording disk or disks 14.

A swinging movement of the carriage 16 around the support shaft 18 in the normal direction D1 allows disengagement between the carriage 16 and the latch member 42. Since the latch member 42 is subjected to the torque in the second direction SD at the restraint position, the latch member 42 swings in the second direction SD. The torque drives the latch member 42 for a swinging movement from the restraint position to the inoperative position. The latch member 42 is thus reliably forced to return to the inoperative position.

The first magnetic piece 49 is subjected to the magnetic attraction of the yoke member in the hard disk drive 11 of the type. The latch member 42 is thus allowed to keep staying at the operative position. This results in a reliable engagement of the latch member 42 with the carriage 16 even if carriage 16 starts swinging later than the swinging movement of the latch member 42. The flying head sliders 22 are thus reliably prevented from contact with the magnetic recording disk or disks 14. The flying head sliders 22 is reliably prevented from any attachment to a lubricant agent covering over the corresponding surfaces of the magnetic recording disk or disks 14.

Next, assume that the hard disk drive 11 is switched on. In this case, first assume that the carriage 16 is located at the standby position while the latch member 42 is located at the operative position. When the hard disk drive 11 has been switched on, the carriage 16 is controlled to receive a driving force in the reverse direction D2. The carriage 16 is thus allowed to swing around the support shaft 18 from the standby position in the reverse direction D2. The protuberance 41 contacts with the latch member 42 located at the operative position in the same manner as described above. A further swinging movement of the carriage 16 allows the entire flat surface 48 to contact with the protuberance 41. The latch member 42 is in this manner positioned at the restraint position. The carriage 16 is then driven to swing around the support shaft 18 in the normal direction D1. The latch member 42 releases the engagement with the carriage 16. The latch member 42 is subjected to the torque in the second direction SD at the restraint position. The latch member 42 is driven back to the inoperative position. A swinging movement of the carriage arms 19 in the reverse direction D2 allows the load tabs 28 to get off from the ramp member 28.

Next, assume that the latch member 42 keeps engagement with the carriage 16 when the hard disk drive 11 has been switched on. The carriage 16 is controlled to receive a driving force in the normal direction D1. The carriage 16 is thus driven to swing around the support shaft 18 in the normal direction D1. The carriage 16 is released from the engagement with the latch member 42. The latch member 42 is subjected to the torque in the second direction SD at the restraint position. The latch member 42 is driven back to the inoperative position. Here, a swinging movement of the carriage arms 19 in the reverse direction D2 causes the load tabs 28 to get away from the ramp member 28. The latch member 42 can in this manner reliably return to the inoperative position even when the latch member 42 has been located at the operative position upon the switch-on of the hard disk drive 11.

What is claimed is:

1. A recording medium drive comprising:
a head actuator member supported on a support shaft for swinging movement around the support shaft;
a voice coil motor connected to the head actuator member for driving the head actuator member;
a protuberance formed on the head actuator member, said protuberance moving along a predetermined movement path around the support shaft;
a latch member supported on a rotation shaft for swinging movement to reach an operative position established on the movement path of the protuberance, said latch member engaging with the protuberance at the operative position; and
a magnetic body located on the latch member, said magnetic body receiving a magnetic attraction of the voice coil motor when the latch member is located at the operative position.

2. The recording medium drive according to claim 1, further comprising a further magnetic body located on the latch member, the further magnetic body receiving the magnetic attraction of the voice coil motor when the latch member is located at an inoperative position established outside the movement path of the protuberance.

3. The recording medium drive according to claim 2, wherein an interval between the rotation shaft and the magnetic body is set larger than an interval between the rotation shaft and the further magnetic body.

4. The recording medium drive according to claim 3, wherein the latch member includes a flat surface designed to contact with the protuberance of the head actuator member.
